(19) United States
(12) Patent Application Publication
(10) Pub. No.: US 2026/0172863 A1
(43) Pub. Date: Jun. 18, 2026

(54) METHODS, ARCHITECTURES, APPARATUSES AND SYSTEMS FOR MANAGING SENSING TASKS IN WIRELESS NETWORKS

(71) Applicant: InterDigital Patent Holdings, Inc., Wilmington, DE (US)

(72) Inventors: Sebastian Robitzsch, London (GB); Abinaya Babu, Illford (GB); Filipe Conceicao, London (GB); Muhammad Awais Jadoon, London (GB)

(21) Appl. No.: 18/981,341

(22) Filed: Dec. 13, 2024

(51) Int. Cl. H04W 24/10; H04W 16/22

(52) U.S. Cl. CPC H04W 24/10; H04W 16/22

(57) ABSTRACT

Procedures, methods, architectures, apparatuses, systems, devices, and computer program products are provided for managing a sensing task in sensing-enabled wireless network. A sensing task management state is managed by moving the sensing task management state between an active state and a paused state. The state may be moved from the active state to the paused state based on the co-occurrence of a transient condition liable to degrade sensing performance and a failure to meet key performance indicators set for the sensing task. A duration for the transient condition may be set. Once that duration has elapsed the sensing task management state may be returned to the active state. A sensing coordination function in the network may manage the sensing task management state of sensing tasks allocated to wireless transmit/receive units served by the wireless network.

### BACKGROUND

The present disclosure is generally directed to the fields of communications, software and encoding, including, for example, to methods, architectures, apparatuses, systems related to managing sensing tasks in wireless networks.

### SUMMARY

This disclosure describes methods performed by a Wireless Transmit/Receive Unit (WTRU) to manage sensing tasks in the wireless network serving the WTRU. The method may involve the WTRU receiving a request to perform a sensing task. The request may include sensing task configuration enabling the WTRU to configure the requested sensing task. In order to manage the sensing task, the sensing task has a sensing task management state associated with it which may initially be set to an active state. Once the sensing task is started, the WTRU may generate sensing data by performing the sensing task in accordance with the sensing task configuration for as long as the sensing task management state is the active state. The WTRU may then receive an indication from the network of a transient condition liable to degrade performance of the sensing task, and, if a determination that one or more sensing performance requirements are not met has also been made, pause the sensing task, and accordingly change the state of the sensing task to a paused state. The WTRU may then transmit an indication to the network that the sensing task management state for the sensing task has been changed to the paused state.

In certain representative embodiments, the determination that one or more sensing performance requirements are met may be made by the WTRU. In other representative embodiments, the determination that one or more sensing performance requirements are met may be made by the network and notified to the WTRU.

This disclosure also describes methods performed by one or more network entities in a wireless communications network. The network entity may receive a request to provide a sensing service from an external application offering a sensing-based service to its users. The request may stipulate key performance indicators to be met by the sensing service. A sensing coordination function in the network may determine at least one WTRU to perform a sensing task in providing the sensing service to the external application. A transient condition detection application may detect a transient condition which is liable to degrade one or more sensing tasks, and notify the sensing coordination function in the network of the presence of the transient condition. The WTRU or the network can determine if a transient condition is present and the key performance indicators are not being met. The WTRU providing the sensing task may then pause the sensing task, and notify the sensing coordination function of the paused state of the sensing task.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates how environmental factors might affect a sensing service;

FIG. 3 is an example of a sensing task management state machine;

FIG. 4 illustrates a procedure for registration of sensing-enabled Wireless Transmit/Receive Units;

FIG. 5A illustrates a first part of a sensing task creation procedure;

FIG. 5B illustrates a second part of the sensing task creation procedure;

FIG. 6 shows an example of configuration data for a sensing receiver;

FIG. 7A illustrates a first part of a sensing task pausing procedure in a first type of sensing procedure;

FIG. 7B illustrates a second part of the sensing task pausing procedure in a first type of sensing procedure;

FIG. 8A illustrates a first part of a sensing task pausing procedure in a second type of sensing procedure;

FIG. 8B illustrates a second part of the sensing task pausing procedure in a second type of sensing procedure;

FIG. 9 illustrates a method performed by a Wireless Transmit/Receive Unit.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

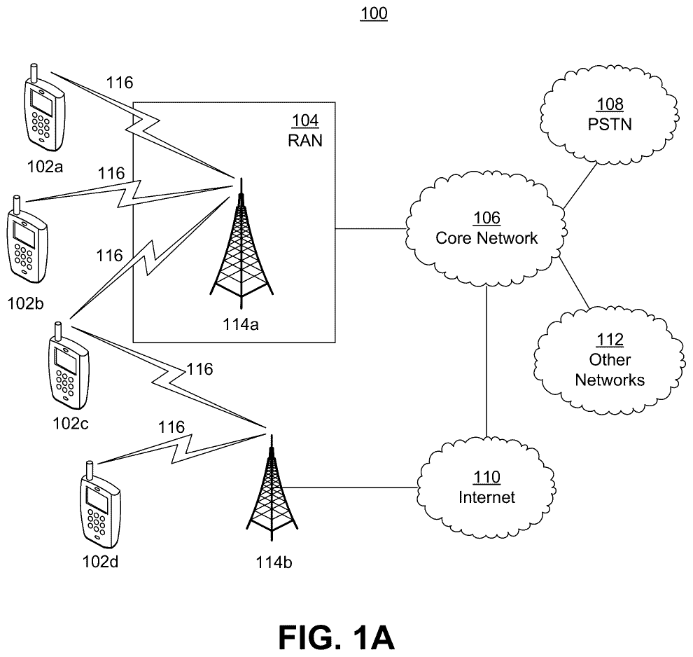

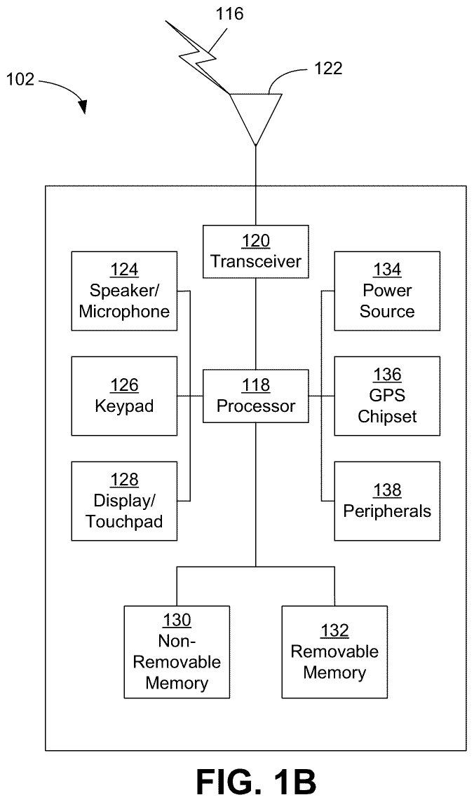

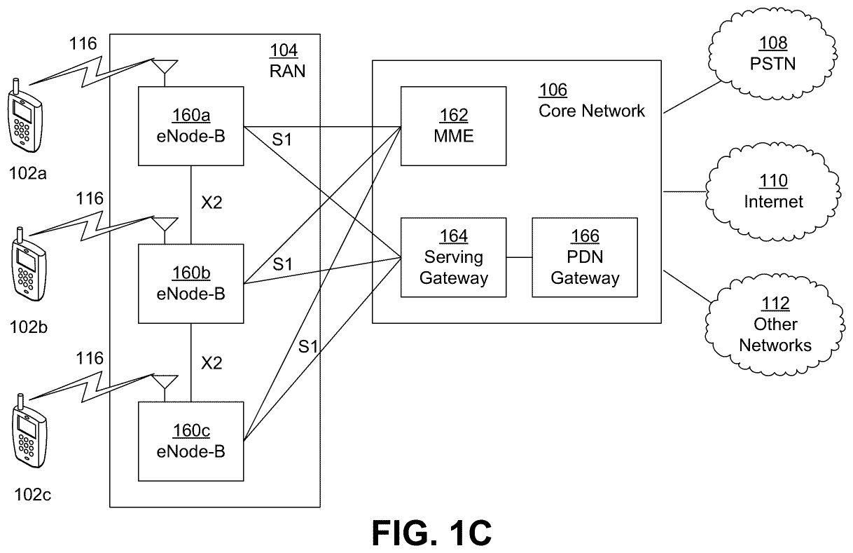

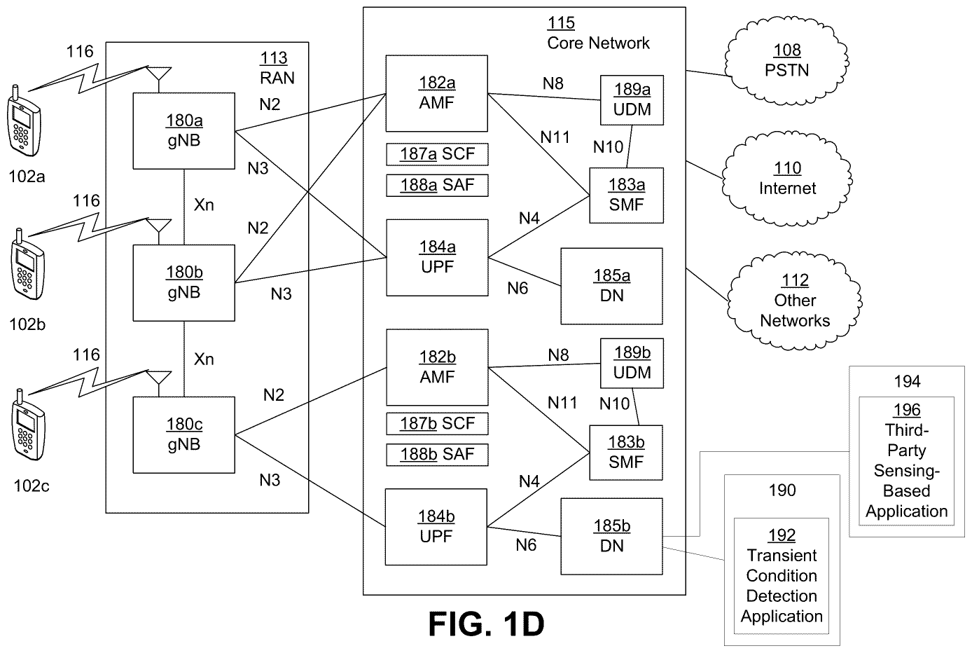

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114 a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel—cadmium (NiCd), nickel—zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, at least one Data Network (DN) 185a, 185b, at least one Unified Data Management function (UDM) 189a, 189b, at least one Sensing Coordination Function (SCF) 187a, 187b and at least one Sensing Analytics Function (SAF) 188a, 188b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The UDM 189a, 189b may be connected to an AMF 182a, 182b in the CN 115 via an N8 interface, and may be connected to an SMF 183a, 183b, via an N10 interface. The UDM 189a, 189b may combine a subscriber database with a front-end that presents the information in the subscriber database to the other functions in the network.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In representative embodiments, the communication system may provide sensing services. Accordingly, a first application server 194, on which a third-party sensing-based application 196 may be installed, may be in communication with the DN 185a, 185b. Alternatively, first application server 194 may be in indirect communication with CN 115 via an external network, such as PSTN 108, Internet 110 or other network 112. A second application server 190, on which a transient condition detection application 192 may be installed, may be in communication with the DN 185a, 185b. Alternatively, second application server 190 may be in indirect communication with CN 115 via an external network, such as PSTN 108, Internet 110 or other network 112. The transient condition detection application 192 may be capable of detecting transient conditions from analyzing sensing data obtained from any active sensing task. As sensing data can include sensitive information and could violate privacy laws and regulations (e. g the European Union's General Data Protection Regulation) in the jurisdiction where the sensing-enabled mobile network is deployed, the transient condition detection application 192 may be a trusted application. In representative embodiments, only trusted applications have sensing data exposed to them.

The SCF 187a, 187b may manage sensing tasks performed by the communication system in providing sensing services to third-party sensing-based applications such as third-party sensing-based application 196. The SAF 188a, 188b may process sensing data to derive sensing results.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

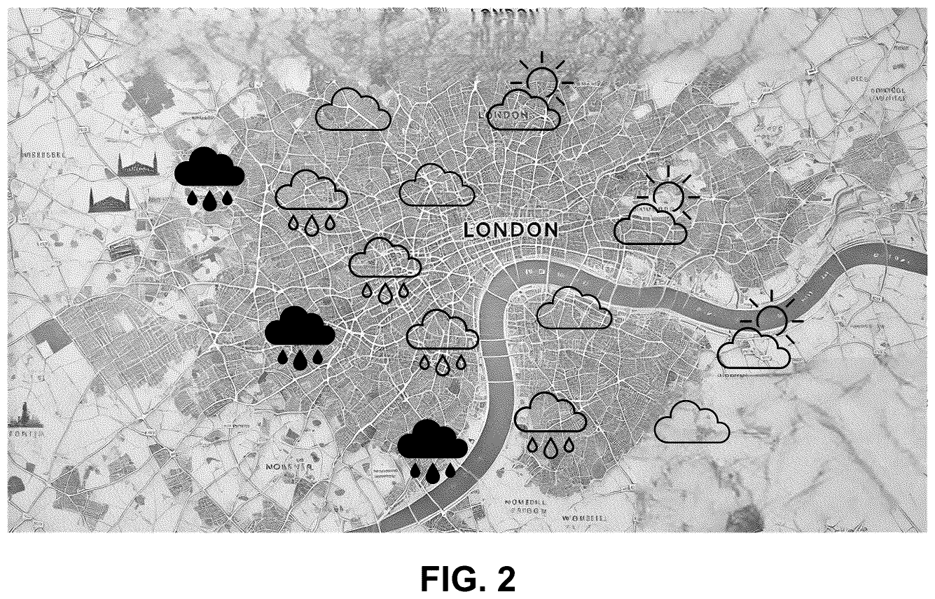

An example of a possible use case of a representative embodiment will now be described with reference to FIG. 2. In a metropolitan city, public sensing-enabled mobile networks may see hundreds of active sensing tasks across the city, demanding a range of resources to be allocated to sensing such as time on licensed frequency bands to exchange sensing signals, networking resource to send sensing-related data across the network and the processing required to measure and produce meaningful sensing results. There might be situations though where there are transient conditions in the city, which can negatively impact the execution of a sensing tasks. Transient conditions may include a change in water density in the air (rainfall, snowfall, fog, humidity/temperature change), a severe change in the environment (e.g. flooding), power outages and other infrastructure-related conditions.

Transient conditions may occur only for certain time with the possibility of recovery thereafter. However, during the duration of transient conditions, wireless signal propagation for sensing tasks around the transient condition can be negatively affected without much the sensing-enabled mobile network can do via reconfigurations such as increasing transmit power on the sensing transmitter. This would however require the system entities involved in a sensing task to consume even more resources, in particular energy, in order to continue working within the expected sensing results Key Performance Indicator (KPI) boundaries. With the possible negative impact on sensing results, which may not meet the sensing service KPIs despite allocation of more resource to cope with the transient condition, continuing sensing tasks may not lead to any useful sensing results with the consequential drawback of energy wastage during the duration of the transient conditions.

A sensing receiver may be an entity that receives the sensing signal which the sensing service may use in its operation. A sensing receiver may be an NR RAN node or a UE. A Sensing receiver can be in the same or different entity as a Sensing transmitter.

A sensing transmitter may be an entity that sends out the sensing signal which the sensing service may use in its operation. A sensing transmitter may be an NR RAN node or a UE. A sensing transmitter may be in the same or different entity as the sensing receiver.

A sensing signal may be a signal transmitted from a sensing transmitter for the purpose of sensing. The signal may be 6G or non-6G.

A sensing measurement report may be a configured report from the sensing receiver.

Sensing data may be the content of a sensing measurement report.

A sensing task group may be a set of sensing transmitters and sensing receivers which work together to fulfil the sensing task in a Target Sensing Service Area (TSSA), allowing sensing receivers to generate sensing data.

Sensing results may be processed sensing data from: i) sensing measurement reports or ii) unprocessed sensing data collected at sensing receivers. The processed sensing data may include, e.g., point cloud, object identification (size, shape, material) or other contextual information about objects in the TSSA using further analytics. Unprocessed sensing data may include angle of arrival, phase, Radar Cross Section (RCS) or Doppler.

A sensing service may be a feature of a 6G System (6GS) that is offered to consumers. A sensing service may provide sensing results based on communicated requirements and KPIs, as per the issued sensing service request.

Pausing a sensing task may mean that the system is actively choosing to stop sensing for a period while remaining ready to resume quickly.

Contextual information may be information that may be exposed with sensing data, sensing measurement reports or sensing results, containing information about the data it accompanies such as timestamps, sensor identifiers or area information.

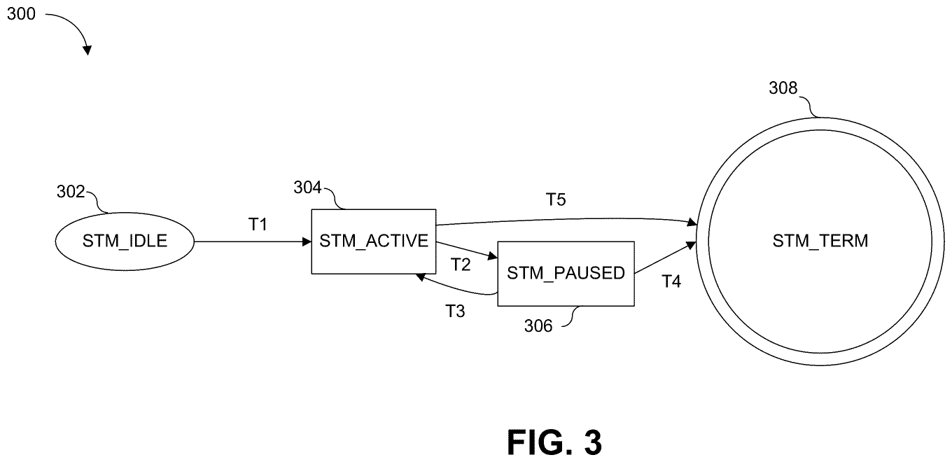

FIG. 3 illustrates an example of a generic state machine in a WTRU, with states and transitions between states, for the purpose of executing sensing tasks including the ability to pause them. The Sensing Task Management (STM) states of the state machine may include STM_IDLE 302, STM_ACTIVE 304, STM_PAUSED 306, and STM_TERM 308.

STM_IDLE may be a state which allows the WTRU to receive a new sensing task request from the network. In representative embodiments, the WTRU only enters this state if it is in CM-CONNECTED state, allowing Control or User Plane communication to arrive from the network.

STM_ACTIVE: This state may put the WTRU in a sensing task management state for sensing. The logic inside the WTRU may depend on whether the WTRU is the sensing transmitter and/or sensing receiver. If the WTRU is the sensing transmitter only, this state may mean that the WTRU is sending out the sensing signal without any further logic. If the WTRU is the sensing receiver, this state may tell the WTRU to receive the sensing signal and to determine sensing data for the purpose of generating one or more sensing measurement reports. Furthermore, based on the UE's capabilities, this state may also involve the WTRU processing sensing data into sensing results; such capability may be referred to as UE-based sensing, whereas a WTRU which sends off the sensing data to be processed elsewhere may be referred to as UE-assisted sensing.

STM_PAUSED: This state may put the WTRU in a sensing task management state for sensing where the WTRU may pause the emission of a sensing signal if it is the sensing transmitter. If the WTRU is the sensing receiver, the WTRU pauses the reception of sensing signals, the measurement of sensing data points and the processing of sensing data (if configured to do so by the network).

STM_TERM: This state may put the WTRU in a sensing management state for sensing in which the WTRU may release all resources for being a sensing transmitter and/or sensing receiver.

The transitions between states shown in FIG. 3 are transitions T1 through T5, which are explained in further detail below.

T1 is the transition from STM_IDLE to STM_ACTIVE, triggered by the network requesting the WTRU to start a sensing task. This request from the network may also contain configurations for the WTRU to know whether it operates as a sensing transmitter and/or sensing receiver and whether the WTRU should process sensing data into sensing results.

T2 is the transition from STM_ACTIVE to STM_PAUSED, which may be triggered by a communication from the network to pause an active sensing task or by internal WTRU logic.

T3 is the transition from STM_PAUSED to STM_ACTIVE, which may be triggered by a communication from the network or by internal WTRU logic to return to the active execution of the sensing task, which may be configured by the network.

T4 is the transition from STM_PAUSED to STM_TERM, which may be triggered by a communication from the network or by internal WTRU logic.

T5 is the transition from STM_ACTIVE to STM_TERM, which may be triggered by a communication from the network to terminate an active sensing task or by internal UE logic. This transition may also cover the case when the WTRU is incapable of pausing sensing tasks, is in STM_ACTIVE, and has received a request from the network to pause an active sensing task.

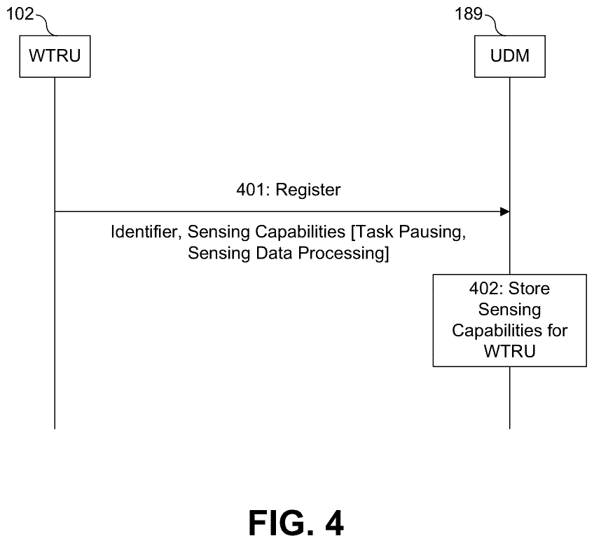

FIG. 4 depicts the procedures which may be used to enable the mobile network to learn the capability of sensing transmitters and sensing receivers to pause active sensing tasks. This capability information may then be used to coordinate the potential pausing of sensing tasks.

Note, while FIG. 4 illustrates WTRUs being sensing transmitters and/or sensing receivers, the steps below cover considerations for sensing transmitters or sensing receivers being a Transmit Receive Point (TRP) or Base Station (BS) too.

The registration process of FIG. 4 may begin with the WTRU registering 401 with the network and communicating its sensing capabilities such as the capability to pause sensing tasks as well as the capability to process sensing data for the purpose of generating sensing results. The WTRU may also provide an identifier for itself, e.g. Subscriber Permanent Identifier (SUPI) or Subscriber Concealed Identifier (SUCI). Note, in case a BS registers with a mobile network, the RAN Node ID may be shared as well as the aforementioned sensing capabilities. Note, the WTRU may also provide its sensing capabilities at a later stage after the registration.

A function in the mobile network, e.g. the UDM 189, may then receive and store 402 the sensing capabilities for a specific WTRU. In the case a BS registered with the mobile network, this network function may be a coordination function for sensing, e.g. SCF 187. In that case the SCF 187 may receive and store sensing capabilities for a BS.

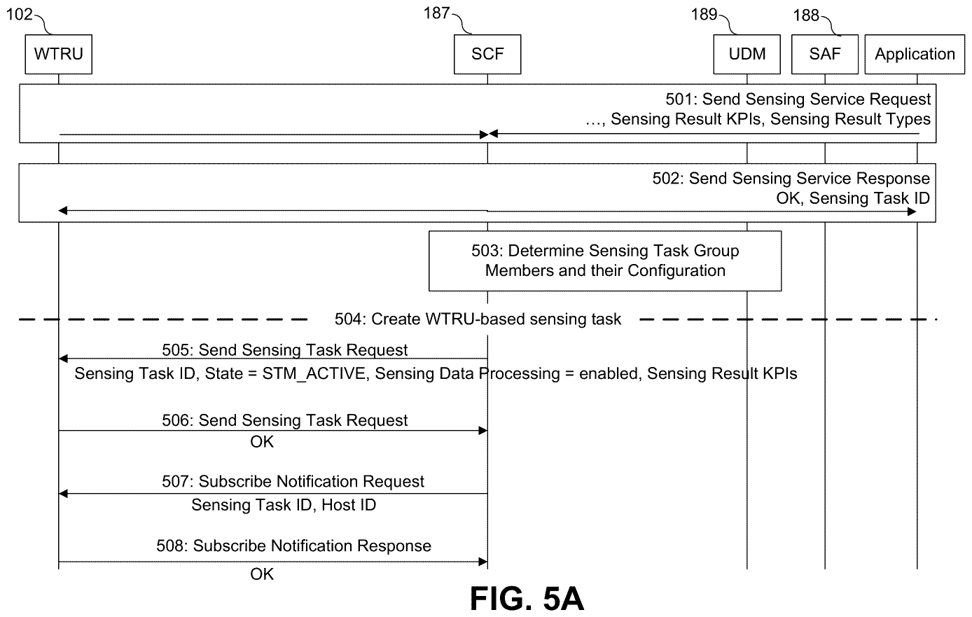

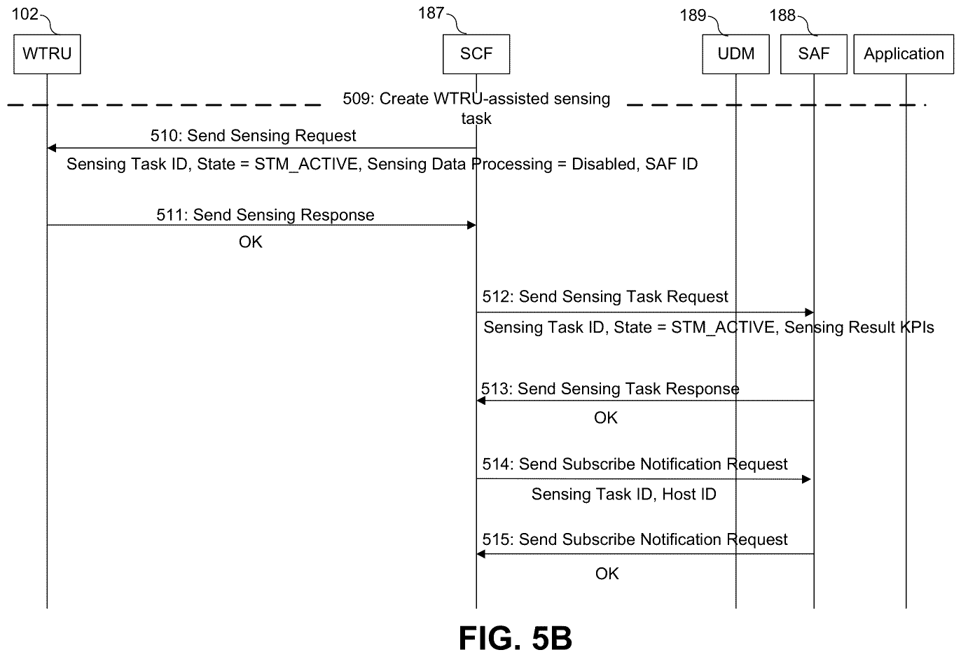

FIG. 5A and FIG. 5B show an example of a sensing task creation process of some representative embodiments. FIG. 5A and FIG. 5B show how, upon the successful registration of a WTRU or BS with the network, sensing tasks may be created with detailed steps which may be followed for the purpose of pausing at any given point in time.

The sensing task creation process may begin with a WTRU, BS or Application sending a sensing service request 501 to the mobile network. The Network Function in the mobile network, e.g., the SCF 187, may receive the sensing service request. The sensing service request may include detailed information about the requested sensing service including the KPIs for the expected sensing results. The request may also include which type of sensing results the Application Server or WTRU/BS expects, i.e. sensing data or processed sensing data (a.k.a. sensing results). The Application may also ask for the exposure of both sensing data and sensing results. It may be up to the mobile network to determine whether sensing data can be shared with the requestee, as sensing data may expose sensitive information about any target object (e.g. human or critical infrastructure). Such mechanism to control the exposure of sensing data may be achieved through policies stored inside the mobile network, based on dedicated agreements between the Application and the mobile network. These mechanisms may allow a mobile network to determine whether the Application requesting sensing data is a trusted entity and will not act unlawfully.

The SCF 187 may respond back to the Application which asked for a new sensing service using a sensing service response message 502 which may contain the action the SCF 187 will take to create a sensing task (e.g. HTTP Response codes such as OK, INTENRAL_SERVER_ERROR, or UNAUTHORIZED) and a sensing task identifier which may uniquely identify future responses in relation to the requested sensing service, such as system errors and system state changes in relation to the sensing task, and the actual requested sensing results.

The SCF 187 may determine 503 the members of a sensing task group, which may act as a sensing transmitter and sensing receiver to send and receive the sensing signal to generate sensing data. To determine the properties of the sensing task, the SCF 187 may utilize a range of capability information from the available sensing transmitters and receivers. The SCF 187 may determine whether the WTRU performs WTRU-based or WTRU-assisted sensing as part of this process. Any WTRU capabilities the SCF 187 requires to make such decision may be obtained by the SCF 187 from the UDM 189, based on capabilities and sensing-related WTRU-specific information using the registration (see FIG. 4) or at a later stage in the operations of a WTRU. For an interaction between the SCF 187 and the UDM 189, the SCF 187 may use a unique identifier for the WTRU, e.g. the SUPI or SUCI.

The SCF 187 may determine whether the WTRU is capable of processing sensing data to sensing results. The SCF 187 may then create 504 a sensing task involving WTRU-based sensing (steps 505 to 508) in cases where the WTRU is capable of processing sensing data to sensing results, or create 509 a sensing task involving WTRU-assisted sensing (steps 510 to 515) if the WTRU is not capable of processing sensing data to sensing results.

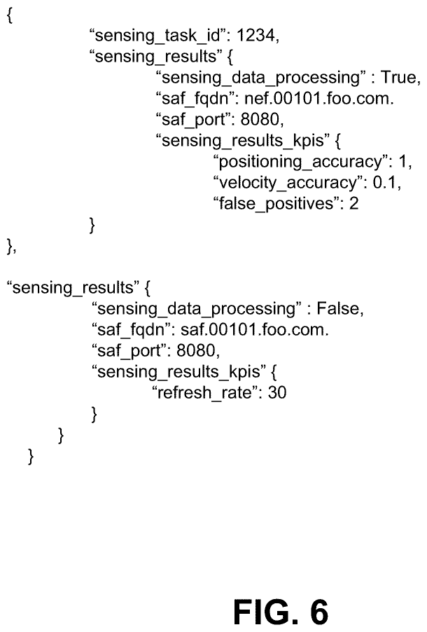

The SCF 187 may request the creation of a new sensing task group from the selected sensing transmitters and sensing receivers identified in step 503. The sensing request 505 is described by a sensing task identifier, an instruction to the WTRU to process sensing data into sensing results (which may be based on the WTRU's capabilities obtained in Step 503), and the sensing result KPIs received in Step 501. The SCF 187 may also inform the WTRU what sensing result type(s) are expected and where to send the sensing results to (either as an IP address, Fully-Qualified Domain Name (FQDN) or Data Network Name (DNN)). Note, the request to the WTRU to create a new sensing task may be sent via the serving BS the WTRU is attached to. In such a scenario, it is the SCF 187 which communicates with the BS to create a new sensing task. An example of the configuration the SCF 187 sends to the WTRU as part of the request is provided in FIG. 6 which will be described in more detail below.

The WTRU may acknowledge 506 the successful creation of the sensing task based on the configurations communicated in Step 505. Note, based on the semantics used for the Control Plane communication with the WTRU (e.g. service-based interface procedures vs unidirectional signaling), there may be no explicit acknowledgement required.

The SCF 187 may request 507 a subscription to events from the WTRU related to the created sensing task. The request for notifications 507 may include the sensing task identifier the SCF 187 wants to receive notifications for and an optional Host Identifier these notifications will need to be sent to. The Host Identifier can be an FQDN or an IP Address, which the SCF 187 may be reached on. If the Host Identifier is not present, the WTRU may use other means to identify the Host Identifier, such as any suitable technique known in the art. Notifications may be sent if state changes inside the WTRU occur in relation to the sensing task, both operational changes the SCF 187 should be made aware about (e.g. WTRU pauses the execution of the sensing task) or errors that prevent the WTRU from functioning as requested by the SCF 187. If the WTRU uses non-service-based interface procedures to communicate with the network, the SCF 187 may not need to explicitly subscribe to sensing task events from the WTRU. In that case the WTRU may send all sensing task events to the network.

The WTRU may confirm 508 the successful creation of the subscription state to report notifications back to the SCF 187.

As mentioned above, if the SCF 187 determines that the WTRU is not capable of processing sensing data to sensing results then steps 510 to 515 may be performed.

The SCF 187 may request the creation a new sensing task from a WTRU by sending a sensing task request 510 to the WTRU which contains a sensing task identifier, the indication that sensing data does not need to be processed, and the identifier where the sensing data may be sent to for either exposure or further processing, e.g. an SAF ID. An example of the configuration the SCF 187 sends to the WTRU as part of the request is shown in FIG. 6.

The WTRU may confirm the successful creation of the subscription state to report notifications back to the SCF by sending a sensing task response 511.

The SCF 187 may request the creation of a new sensing task from the SAF 188 by sending a sensing task request 512 to the SAF 188, comprising a sensing task identifier (determined in Step 501), the sensing task management state STM_ACTIVE and the sensing results KPIs (provided by the Third-Party Sensing-Based Application 196 in Step 501).

The SAF 188 may set up the new sensing task and may respond back to the SCF 187 with a sensing task response 513, which may comprise the outcome of the sensing task creation, e.g. OK.

Upon the successful creation of the sensing task in Steps 510 and 511, the SCF may send a subscription request 514 to the SAF 188, asking for any events related to the processing of sensing data the SAF 188 may have. The request may contain the sensing task identifier determined in Step 503 and communicated to the sensing receivers, and an optional Host Identifier allowing the SCF 187 to configure where the notifications may be sent to.

The SAF 188 may confirm 515 the successful creation of the subscription state to report notifications back to the SCF 187.

FIG. 6 illustrates an example configuration for the sensing request (Step 505 and Step 510), following JavaScript Object Notation (JSON) format commonly used as HTTP-based configuration exchange, allowing machines to swiftly parse the information. Note, the example configuration demonstrates how a single sensing receiver can provide unprocessed and processed sensing data from a single sensing task.

As explained above in relation to FIG. 1D, a trusted Transient Condition Detection Application 192 may be deployed. The trusted Transient Condition Detection Application 192 may perform measurements to determine the impact of transient conditions on the sensing task in general and on the sensing signal in particular. The trusted Transient Condition Detection Application 192 may also leverage the procedures of Third-Party Sensing-Based Applications 196 to request a sensing service from the mobile network in order to receive sensing results. As the trusted Transient Condition Detection Application 192 may not utilize dedicated sensing task resources to obtain sensing results (unprocessed sensing data in that case to perform its own processing and analytics), the sensing service request issued by the trusted Transient Condition Detection Application 192 may have the TSSA field set to “Any”, the sensing results type set to “Sensing Data” and the sensing results KPI sparsely provided, e.g. only providing refresh rate.

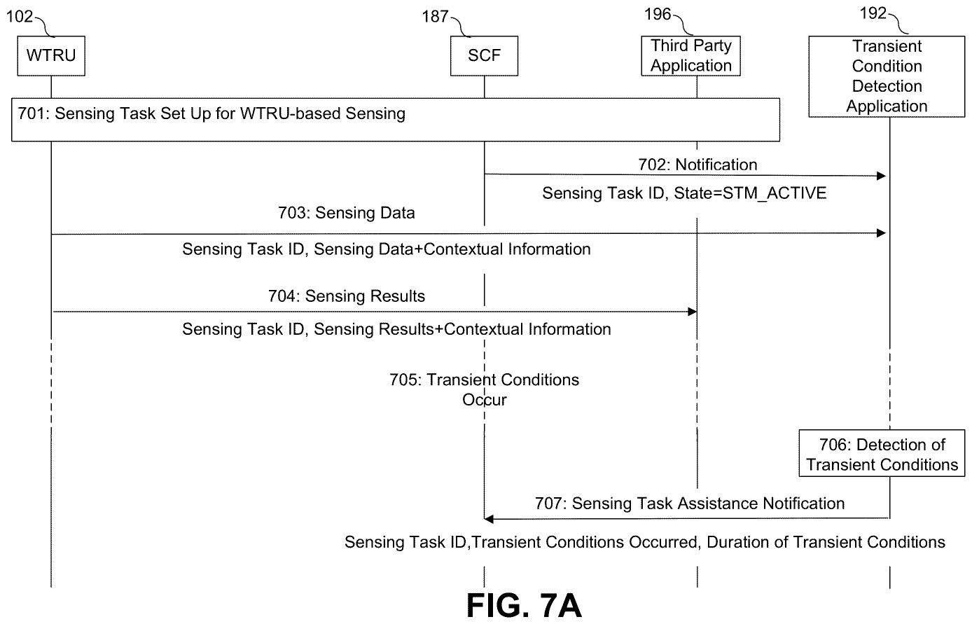

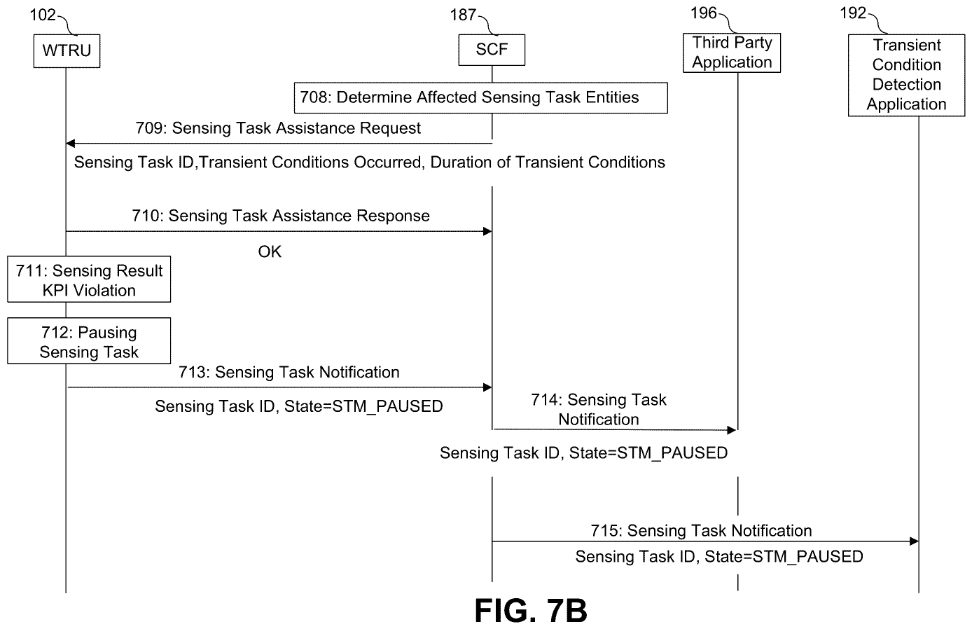

FIG. 7A and FIG. 7B illustrate example methods and procedures for pausing WTRU-Based sensing tasks in which WTRUs may act as a sensing receiver and process sensing data into sensing results. As mentioned above, this may be referred to as WTRU-based sensing. Note, the procedures here may also cover BSs acting as the sensing receiver and performing the processing of sensing data into sensing results. FIG. 7A and FIG. 7B depict the procedures for WTRU-based sensing with two applications, a trusted Transient Condition Detection Application 192 and a Third-Party Sensing-Based Application 196, where the Third-Party Sensing-Based Application 196 application may have requested the mobile network to provide processed sensing data and the trusted Transient Condition Detection Application 192 unprocessed sensing data for the purpose of detecting transient conditions and assisting the network on potential pausing of sensing tasks.

Based on a sensing service request from the WTRU/BS or a Third-Party Sensing-Based Application 196, a new sensing task may be set up, following the method described above in relation to FIG. 5A. Furthermore, the trusted Transient Condition Detection Application 192 may also have requested a sensing service but indicated in a sensing service request that it requires the sensing data from active sensing tasks (see Step 501 in FIG. 5A). Note that the SCF 187 may be aware of the sensing service request from the trusted Transient Condition Detection Application 192 and the SCF 187 may have configured the sensing receiver(s) in the sensing task group to generate sensing results to be exposed to the Third-Party Application 196. The SCF 187 may also have configured the sensing receiver(s), i.e. WTRU here, to generate sensing data (see configuration example of such sensing request in FIG. 6).

Upon the successful completion of setting up the new sensing task in Step 701, the SCF may notify 702 the trusted Transient Condition Detection Application 192 about the new sensing task and that the mobile network will be sharing sensing data. The notification 702 may comprise the sensing task ID, which is the one the SCF 187 determined in Step 701 for the sensing task for the Third-Party Application 196, as well as the state of the sensing task, e.g. STM_ACTIVE.

Based on the active sensing task, the WTRU (acting as a sensing receiver) may collect sensing data and may send 703 the sensing data together with contextual information and a sensing task identifier to the trusted Transient Condition Detection Application 192.

Based on the active sensing task, the WTRU (acting as a sensing receiver) may collect sensing data, processes the sensing data into sensing results and may send 704 the sensing results together with contextual information to the Third-Party Application 196.

At some point in time, a transient condition occurs 705 in the area where sensing takes place, which negatively affects the sensing signal used at the sensing receiver to collect the sensing data.

The trusted Transient Condition Detection Application 192 may continuously assess the sensing data which the WTRU sends in Step 703. The trusted Transient Condition Detection Application 192 may determine 706 that a transient condition occurred and that it may cause violation of sensing results KPIs. For instance, the trusted Transient Condition Detection Application 192 could detect the water density in the air and may determine that heavy rain or snow occurred, and that the propagation of sensing signals may be heavily impacted. The trusted Transient Condition Detection Application 192 might also use AI or other sources to predict the duration of the transient condition.

The trusted Transient Condition Detection Application 192 may send a Sensing Task Assistance Notification to the SCF 187, indicating that a transient condition occurred and that the mobile network can consider the pausing of a sensing task. The notification 707 comprises the sensing task ID for which the trusted Transient Condition Detection Application 192 detected the occurrence of transient condition, the information that the sensing task can be paused and, optionally, a duration of the transient condition.

Moving now to FIG. 7B, the SCF 187 may determine all system entities that are part of the sensing task using the sensing task ID shared by the trusted Transient Condition Detection Application 192 in Step 707. As a result, the SCF 187 may find that it configured the WTRU as a sensing receiver which processes sensing data into sensing results.

Based on Step 708, the SCF 187 may send a Sensing Task Assistance Request 709 to the WTRU, informing the WTRU that a transient condition occurred and that if sensing results KPIs are violated at any point in time, a pausing of the sensing task can be enabled. The request 709 from the SCF 187 may comprise the sensing task ID the assistance information is provided for, the information that a transient condition occurred and an optional information for how long the transient condition may persist.

The WTRU may confirm the request sent in Step 709 by sending a Sensing Task Assistance Response 710 back to the SCF 187, which may comprise the status of processing the request, e.g. OK.

As the WTRU processes sensing data into sensing results and the SCF 187 shared the sensing results KPIs with the WTRU in Step 701, the WTRU may assess the sensing results against the sensing result KPIs and may determine 711 that the KPIs are violated. For instance, the WTRU may check for one or more of relative distance, velocity and micro-movement accuracies, and may determine that they are violating the received KPIs.

As the WTRU has received the sensing task assistance information in Step 709 and determined that the sensing results KPIs have been violated in Step 711, the WTRU may pause 712 the sensing task.

The WTRU may send a Sensing Task Notification 713 to the SCF 187, indicating that the WTRU has decided to pause the sensing task. The notification 713 may comprise the sensing task ID and the sensing task management state the WTRU is in, i.e. STM_PAUSED. Note, the WTRU may send the notification 713 to the SCF 187 based on the SCF 187 having subscribed to events related to the sensing task (Step 507 and 508 in FIG. 5A).

The SCF 187 may send a notification 714 to the Third-Party Application 196, in representative embodiments, notifying it that the sensing task has been paused and that no sensing results will arrive until further notice. The notification may comprise the sensing task ID and the state of the sensing task, i.e. STM_PAUSED.

The SCF 187 may also inform the trusted Transient Condition Detection Application 192 that a Sensing Task has been paused. The notification sent by the SCF may comprise the same information as notification 714, i.e. the affected sensing task ID and the new state of the sensing task (i.e. STN_PAUSED).

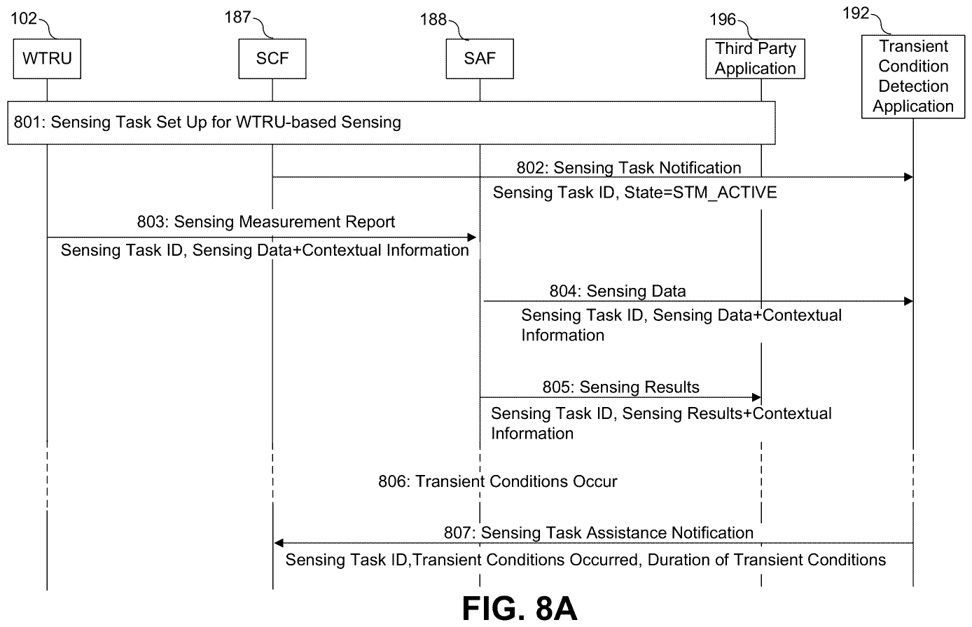

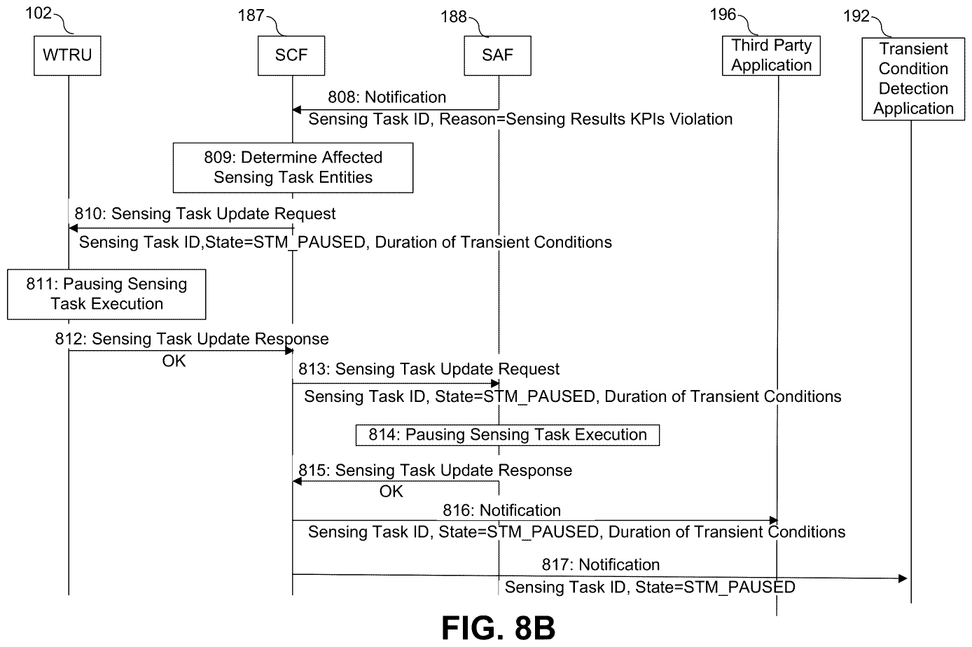

FIG. 8A and FIG. 8B illustrate example methods and procedures for pausing of WTRU-Assisted sensing tasks. Based on a sensing service request from the WTRU/BS or a Third-Party Application 196, the SCF 187 may set up a new sensing task, following the steps in FIG. 5B for WTRU-Assisted Sensing. Furthermore, the trusted Transient Condition Detection Application 192 may have also requested a sensing service but indicated in the sensing service request that it requires the sensing data from active sensing tasks (see Step 501 in FIG. 5A). Note that the SCF 187 may have configured the SAF 188 to generate sensing results to be exposed to the Third-Party Application 196 and the SCF 187 may have also configured the SAF 188 to forward sensing data to the trusted Transient Condition Detection Application 192 (see configuration example of such Sensing Request in FIG. 6).

Upon the successful creation of the new sensing task in Step 801, the SCF 187 may inform 802 the trusted Transient Condition Detection Application 192 about the new sensing task and may send a Sensing Task Notification 802 which may comprise the sensing task ID created in Step 801 and the state of the sensing task, e.g. STM_ACTIVE.

The WTRU may start sending Sensing Measurement Reports to the SAF 188. The Sensing Measurement Report may comprise the sensing task ID and the sensing data including contextual information for the sensing data.

The SAF 188 may generate sensing data out of the Sensing Measurement Report, according to the SCF's configuration of the SAF 188 during the creation of the sensing task (Step 801). While the sensing data in the Sensing Measurement Report is considered identical in its sensing data points, the SAF 188 may adhere to the sensing results KPIs received for sending the sensing data to the trusted Transient Condition Detection Application 192, e.g. the refresh rate. As a result, the SAF 188 may apply basic statistical methods (averaging, standard deviation, confidence levels) to the data in the Sensing Measurement Report before sending the sensing data to the trusted Transient Condition Detection Application 192.

The SAF 188 may have processed the received Sensing Measurement Report(s) from the WTRU in Step 803 and may send the sensing results 805 to the Third-Party Application 196. The message 805 may comprise the sensing task ID as well as the sensing results and their contextual information.

At some point in time, transient conditions occur 806 in the vicinity of where sensing takes place for the sensing task created in step 801.

Based on the continuous assessment of sensing data by the trusted Transient Condition Detection Application 192, the Transient Condition Detection Application 192 may send a Sensing Task Assistance Notification 807 to the mobile network, which may be received by the SCF 187. The notification 807 may comprise the sensing task ID, the notification reason (that a transient condition occurred) and an optional indication of how long the transient condition may persist.

Moving now to FIG. 8B, the SCF 188 may continuously assess the generated sensing results against the sensing results KPIs it received when the SCF 188 set up the sensing task in Step 801. Based on this assessment, the SAF 188 may detect that sensing results KPIs are violated due to the transient conditions and may send a notification 808 to the SCF 187. The notification 808 may comprise the sensing task identifier and the reason for the notification, allowing the SCF 187 to take appropriate actions.

The SCF 187 may determine 809 the Sensing Task Group members based on the sensing task ID in the notification 808. Additionally, the SCF 187 may determine that it has received the indication from the trusted Transient Condition Detection Application 192 about the occurrence of a transient condition and may decide to pause the sensing task.

The SCF 187 may send a Sensing Task Update Request 810 to the WTRU (which is a member of the Sensing Task Group), consisting of the sensing task identifier for which the SCF is sending a new STM state and the requested next STM state itself, i.e. STM_PAUSED. The notification may include the duration of the transient condition, obtained by the SCF 807.

Using the sensing task ID provided in Step 810, the WTRU may pause 811 any sensing activities related to the sensing task. If the WTRU acts as the sensing transmitter, it stops sending the sensing signal; if the WTRU acts as the sensing receiver, it stops measuring sensing data points from the sensing signal and pauses the reporting of the sensing data as Sensing Measurement Reports.

Upon the successful completion of pausing the indicated sensing task in Step 811, the WTRU may confirm that it has entered the state STM_PAUSED by responding to the Sensing Task Update Request in Step 810 with a Sensing Task Update Response 812, comprising the outcome of Step 811 (which is OK in FIG. 8B).

In Step 809, the SCF 187 may have identified the SAF 188 as part of the sensing task and may send a Sensing Task Update Request 813 to the SAF 188. The request 813 may comprise the sensing task ID the update is concerned about and the requested state change, in this example, STM_PAUSED. The request 813 may also comprise the duration of the transient condition.

Using the sensing task ID, the SAF 188 may check for any sensing task activities (processing/analytics) and may pause 814 them.

The SAF 188 may confirm the successful pausing of its sensing task execution by sending a Sensing Task Update Response 815 to the SCF 188. The Sensing Task Update Response 815 may comprise the outcome of Step 814, i.e. OK (sensing task paused).

With the entire sensing task now paused in the system, the SCF 187 may send a notification 816 to the Third-Party Application 196, informing the application 196 that the sensing task has been paused and no sensing results will be shared until further notice. The notification may comprise the affected sensing task ID and the new state of the sensing task, i.e. STM_PAUSED. The notification may also comprise the duration of the transient condition.

The SCF 187 may also inform the trusted Transient Condition Detection Application 192 that a sensing task has been paused. The notification 817 may comprise the affected Sensing Task ID and the new state of the Sensing Task, i.e. STM_PAUSED.

In representative embodiments, pausing of sensing tasks in WTRU-based scenarios may comprise the following steps.

The WTRU may share its capabilities to pause Sensing Tasks and to process sensing data with the mobile network.

The WTRU may receive a sensing task request which may comprise a configuration to create a new sensing task. The request may comprise the following fields: i) a sensing task identifier, ii) the state for executing the sensing task (STM_ACTIVE or STM_PAUSED), iii) a field to indicate that the WTRU shall process sensing data into sensing results, iv) the sensing results KPIs to assess the processed sensing data, and v) sensing data shall be shared with the network unprocessed on top of the processed sensing data (a.k.a. sensing results).

Upon the successful parsing of the received sensing task configuration and initiation of the sensing task, the WTRU may respond back to the network with a Sensing Task Response indicating it has created the sensing task successfully.

The WTRU may receive a subscription request from the mobile network for any event related to a sensing task. The subscription request may include the sensing task ID for which events should be shared and an optional Host ID that identifies where the information about events should be sent to.

The WTRU, which acts as a sensing receiver, may measure sensing data points and may send unprocessed sensing data and their contextual information about the sensing data to the network, including the sensing task ID which was provided in the sensing task configuration.

The WTRU may process sensing data into sensing results and may send the sensing results and their contextual information to the network, including the sensing task identifier provided by the network in the sensing task configuration.

The WTRU may receive a Sensing Task Assistance Request, indicating that a transient condition has occurred for a specific sensing task and optionally the duration of the transient condition. The sensing task may be identified by a sensing task ID.

The WTRU may acknowledge the Sensing Task Assistance Request back to the network with a Sensing Task Assistance Response.

While processing sensing data into sensing results and assessed against the provided sensing results KPIs in the sensing task configuration, the WTRU may conclude that Sensing Results KPIs are violated. Based on the information that a transient condition has occurred; the WTRU may decide to pause the sensing task and may move to the Sensing Task Management state STM_PAUSED.

The WTRU may inform the network about the STM state change and may send a Sensing Task Notification to the network including the affected sensing task identifier and the new state, i.e. STM_PAUSED. The host identifier this notification is sent to may be implicitly known to the WTRU or may be explicitly set by the network in the subscription request received from the mobile network.

In representative embodiments, pausing of sensing tasks in WTRU-Assisted scenarios may involve the following steps.

The WTRU may share its capabilities with the network that it can pause sensing tasks and that it cannot process sensing data.

The WTRU may receive a sensing task request which may comprise a configuration to create a new sensing task. The request may comprise the following fields: i) a sensing task identifier, ii) the state for executing the sensing task (STM_ACTIVE or STM_PAUSED), and iii) a field to indicate that the WTRU does not need to process sensing data into sensing results.

Upon the successful parsing of the received sensing task configuration and initiation of the sensing task, the WTRU may respond back to the network with a Sensing Task Response indicating it has created the sensing task successfully.

The WTRU, acting as a sensing receiver, may start measuring sensing data points and may generate a Sensing Measurement Report which the WTRU may send to the network. The Sensing Measurement Report may include the sensing task identifier provided in the sensing task configuration, the sensing data and their contextual information.

The WTRU may receive a Sensing Task Update Request from the network which may include a sensing task identifier and a new Sensing Task Management state, i.e. STM_PAUSED.

The WTRU may identify an on-going sensing task which is in STM_ACTIVE state and may pause it, for example, the WTRU stops measuring sensing data points and does not send any Sensing Measurement Reposts to the network.

The WTRU may send a Sensing Task Update Response to the network, confirming it has changed the Sensing Task Management state, as requested in the Sensing Task Update Request.

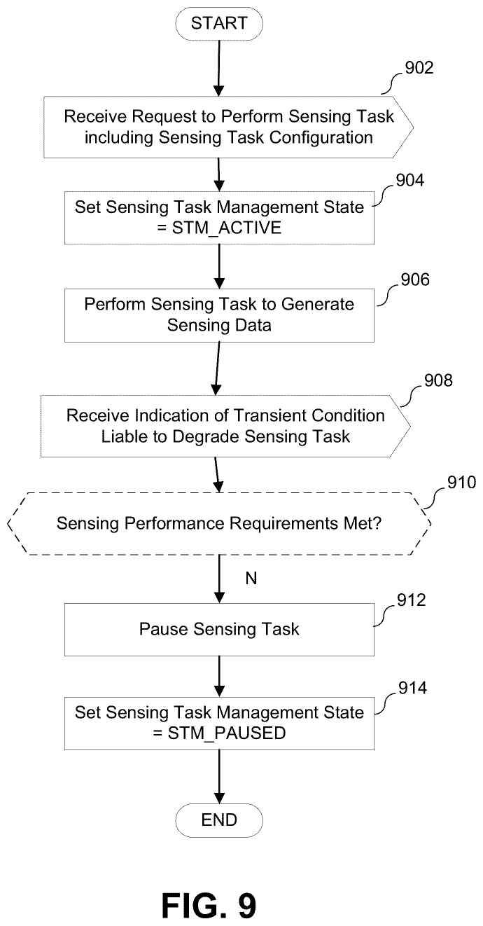

FIG. 9 is a flow-chart illustrating a representative embodiment of a method performed by a WTRU in managing a sensing task.

The method may begin with the receipt 902 of a request to perform a sensing task including sensing task configuration.

The WTRU may then set 904 a sensing task management state to an active state, and may perform 906 the sensing task to generate sensing data.

Whilst the sensing task management state is an active state, the WTRU may receive 908 an indication of a transient condition liable to degrade the sensing task it is performing. A determination that sensing performance requirements are not met 910 is then made by the WTRU, or a network entity. If the determination finds that the sensing performance requirements are not met, then the WTRU may pause 912 the sensing task, and may set 914 the sensing task management state to a paused state.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a Wireless Transmit/Receive Unit (WTRU) in communication with a wireless network, the method comprising:
receiving a request to perform a sensing task, the request comprising sensing task configuration;
setting a sensing task management state of the sensing task to an active state;
performing the sensing task in accordance with the sensing task configuration to generate sensing data while the sensing task management state is the active state;
receiving a first indication from the wireless network of a transient condition liable to degrade performance of the sensing task;
changing the sensing task management state of the sensing task to a paused state based on the indicated transient condition and a determination that one or more sensing performance requirements are not met;
pausing the performance of the sensing task while the sensing task management state of the sensing task is the paused state; and
transmitting a second indication to the wireless network that the sensing task management state for the sensing task has been changed to paused.

2. The method of claim 1 wherein the sensing task configuration further comprises the one or more sensing performance requirements, the method further comprising:
processing sensing data to derive sensing results; and
determining that the one or more sensing performance requirements are not met based on the derived sensing results and the one or more sensing performance requirements to provide the determination that one or more sensing performance requirements are not met.

3. The method of claim 1 further comprising transmitting the sensing data to the wireless network, wherein receiving the first indication from the wireless network of the transient condition liable to degrade performance of the sensing task comprises receiving an instruction to change the sensing task management state of the sensing task to the paused state based on a network-based determination of a co-occurrence of the transient condition and a failure to meet one or more sensing performance requirements.

4. The method of claim 1 wherein the sensing task configuration comprises a sensing task identifier.

5. The method of claim 1 wherein the sensing task configuration comprises an indication that the WTRU is to process sensing data to derive sensing results.

6. The method of claim 1 further comprising transmitting a sensing task response to the wireless network indicating successful creation of the requested sensing task.

7. The method of claim 1 wherein the transient condition notification comprises a duration for the transient condition, the method further comprising changing the sensing task management state of the sensing task back to the active state once the duration for the transient condition has elapsed.

8. The method of claim 1 further comprising transmitting to the wireless network an indication of a capability to pause the sensing task.

9. The method of claim 1 further comprising transmitting to the wireless network an indication of a capability to process sensing data to derive sensing results.

10. A Wireless Transmit/Receive Unit (WTRU) comprising:
a processor; and
a transceiver coupled to the processor, wherein the WTRU is configured to:
receive a request to perform a sensing task, the request comprising sensing task configuration;
set a sensing task management state of the sensing task to an active state;
perform the sensing task in accordance with the sensing task configuration to generate sensing data while the sensing task management state is the active state;
receive a first indication from a wireless network of a transient condition liable to degrade performance of the sensing task;
change the sensing task management state of the sensing task to a paused state based on the indicated transient condition and a determination that one or more sensing performance requirements are not met;
pause the performance of the sensing task while the sensing task management state is the paused state; and
transmit a second indication to the wireless network that the sensing task management state has been changed to paused.

11. The WTRU of claim 10, wherein the sensing task configuration further comprises the one or more sensing performance requirements, and the WTRU is further configured to:
process sensing data to derive sensing results; and
determine that the one or more sensing performance requirements are not being met based on the derived sensing results and the one or more sensing performance requirements to provide the determination that one or more sensing performance requirements are not met.

12. The WTRU of claim 10, wherein the WTRU is further configured to transmit the sensing data to the wireless network, wherein receiving the first indication from the network of the transient condition liable to degrade performance of the sensing task comprises receiving an instruction to change the sensing task management state of the sensing task to the paused state based on a network-based determination of a co-occurrence of the transient condition and a failure to meet one or more sensing performance requirements.

13. The WTRU of claim 10, wherein the sensing task configuration comprises a sensing task identifier.

14. The WTRU of claim 10, wherein the sensing task configuration comprises an indication that the WTRU is to process sensing data to derive sensing results.

15. The WTRU of claim 10, wherein the WTRU is further configured to transmit a sensing task response to the wireless network indicating successful creation of the requested sensing task.

16. The WTRU of claim 10 wherein the transient condition notification comprises a duration for the transient condition, and the WTRU is further configured to change the sensing task management state of the sensing task back to the active state once the duration for the transient condition has elapsed.

17. The WTRU of claim 10, wherein the WTRU is further configured to transmit an indication of a capability to pause a sensing task to the network.

18. The WTRU of claim 10, wherein the WTRU is further configured to transmit to the wireless network an indication of a capability to process sensing data to derive sensing results.

19. A method performed by one or more network entities in a wireless communications network, the method comprising:
receiving a request to provide a sensing service;
determining at least one WTRU to perform a sensing task for providing the sensing service;
determining a transient condition liable to degrade the sensing task;
transmitting a transient condition indication to the WTRU; and
receiving an indication from the WTRU that the WTRU has changed a sensing task management state for the sensing task to a paused state.

20. The method of claim 19 wherein:
determining the transient condition liable to degrade the sensing task comprises determining a duration of the transient condition;
the request comprises one or more sensing performance requirements for the sensing service, the method further comprising:
receiving sensing data from the WTRU;
processing the sensing data to derive sensing results;
determining that the sensing results do not meet the one or more sensing performance requirements; and
transmitting a message to the WTRU instructing the WTRU to change the sensing task management state for the sensing task to the paused state, the message indicating the duration of the transient condition.
